(19) United States
(12) Patent Application Publication
(10) Pub. No.: US 2011/0223963 A1
(43) Pub. Date: Sep. 15, 2011

(54) MAXIMUM TRANSMIT POWER CONTROLLER

(75) Inventor: Vikas Vinayak, Menlo Park, CA (US)

(73) Assignee: QUANTANCE, INC., San Mateo, CA (US)

(21) Appl. No.: 13/033,524

(22) Filed: Feb. 23, 2011

Related U.S. Application Data
(60) Provisional application No. 61/313,569, filed on Mar. 12, 2010.

(51) Int. Cl. H04W 52/04

(52) U.S. Cl. 455/522

(57) ABSTRACT

A maximum transmit power controller determines the amount of power available from a host device for powering a radio transmitter of a mobile device, and sets a limit for maximum transmit power in the radio transmitter based upon the determined amount of available power from the host device. As a result, it can be ensured that the radio transmitter does not transmit RF signals at transmit power levels exceeding the amount of power available from the host device. The host device may be a smartphone including the radio. The host device may also be a computer powering the mobile device via a peripheral interface such as a USB interface.

### CROSS-REFERENCE TO RELATED APPLICATION

This application claims priority under 35 U.S.C. §119(e) from co-pending U.S. Provisional Patent Application No. 61/313,569, entitled “Maximum Transmit Power Controller,” filed on Mar. 12, 2010, which is incorporated by reference herein in its entirety.

### BACKGROUND OF THE INVENTION

1. Field of the Invention

The present invention relates to controlling the maximum transmit power level of radio transmitters of mobile communication devices.

2. Description of the Related Arts

Mobile electronic devices such as smartphones, cellular phones, wireless WAN, USB WAN modems, etc. often operate in conjunction with a host device such as a computer and may be powered by the host device. The host device may have limited power or the interface between the host device and the mobile device may have limited capability to provide power to the mobile device. On the other hand, mobile devices include radio transmitters that transmit signals at a power level according to commands received by the radio from a cellular basestation. In some circumstances, the cellular basestation may command the mobile device to transmit signals at a power level exceeding the maximum power that can be provided by the host device or by the interface between the host device and the mobile device.

### SUMMARY OF THE INVENTION

Embodiments of the present invention include a maximum transmit power controller that determines the amount of power available from a host device for powering a radio transmitter of a mobile device, and sets a limit for maximum transmit power in the radio transmitter based upon the determined amount of available power from the host device, thereby ensuring that the radio transmitter does not transmit radio signals at power levels exceeding this available power.

In one embodiment, the host device is a smartphone or a cellular telephone including radio functions for wirelessly transmitting and receiving signals. The maximum transmit power controller in this embodiment determines the amount of power available from the host smartphone or cellular telephone, and sets the maximum transmit power in the radio transmitter so as not to exceed such determined amount of available power.

In another embodiment, the host device is a computer and the mobile device is a wireless modem powered by the host computer via a peripheral interface such as a USB port and operating in conjunction with the host computer to wirelessly transmit or receive data. In such embodiment, the maximum transmit power controller determines the available current from the USB port on the computer, and sets a limit for maximum transmit power in the radio transmitter that is connected to the USB port, thereby ensuring that the radio transmitter does not exceed this power available from the USB port.

The maximum transmit power controller according to the various embodiments described herein has the advantage of adjusting the maximum transmit power level in the radio transmitter, so as to maximize transmit power (and thus coverage) of the mobile device, while at the same time ensuring that excessive power is not drawn by the radio transmitter from the host device.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 illustrates a maximum transmit power controller according to one embodiment.

FIG. 2 illustrates a maximum transmit power controller according to another embodiment.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

According to various embodiments herein, a maximum transmit power controller determines the amount of power available from a host device powering a radio transmitter of a mobile device, and sets a limit for maximum transmit power in the radio transmitter based upon the determined amount of available power from the host device. As a result, it can be ensured that the radio transmitter does not transmit radio signals at power levels exceeding the power available from the host device.

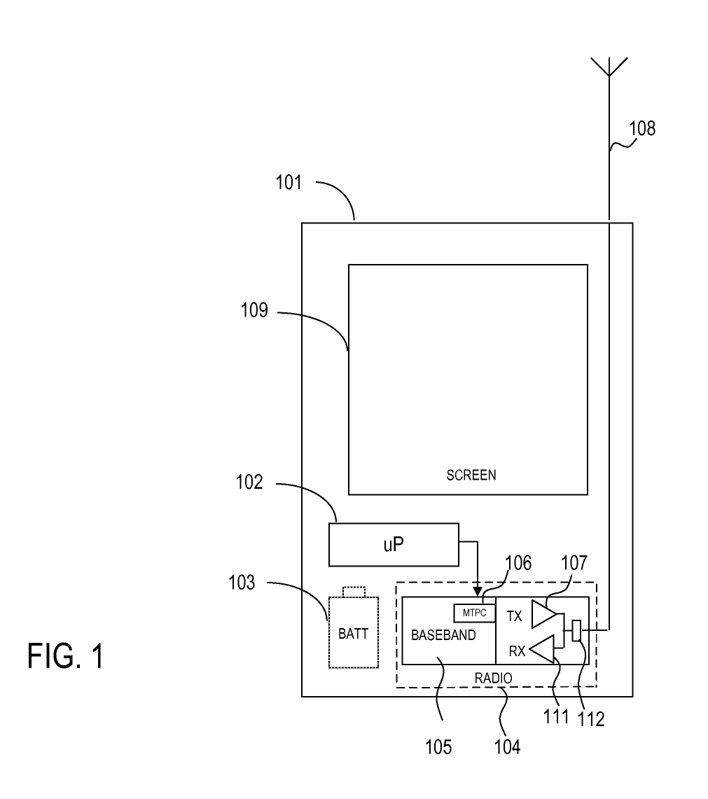

FIG. 1 illustrates a maximum transmit power controller according to one embodiment. FIG. 1 shows a mobile device 101, such as a personal digital assistant (PDA) phone or a smartphone or other types of cellular telephones. The mobile device includes radio 104, which may provide wireless data connectivity with a cellular network; thus the mobile device 101 may be connected to the internet through the cellular network. Radio 104 includes an RF transmitter 107 which transmits an RF signal through antenna 108, an RF receiver 111 which receives RF signals through antenna 108, a duplexer 112 that allows selective connection of either RF transmitter 107 or RF receiver 111 to antenna 108, and a baseband section 105. The baseband section 105 may be a baseband processor which includes software for processing radio signals, and includes Maximum Transmit Power Controller (MTPC) block 106. MTPC block 106 may include a lookup table which provides information of the power consumption of radio 104 versus transmitting power level of TX 107.

Mobile device 101 operates in a number of operation modes, placing varying demands on battery 103 that powers the mobile device 101. For example, display screen 109 may be a liquid crystal display (LCD) that includes either a backlight which draws substantial current from battery 103 when turned on. Microprocessor (uP) 102 is a processor separate from baseband processor 105 and provides the general computing functions of the mobile device 101. Microprocessor 102 may operate in a mode where full motion video is displayed on screen 109, placing further power demands on battery 103. During these modes of heavy power drain, it is desirable to lower the current drain from the battery 103 due to transmission of signals by radio 104, in order to preserve battery life of the mobile device 101.

One opportunity to limit current drain in radio 104 is to reduce the maximum power level at which transmitter (TX) 107 is allowed to transmit a radio signal through antenna 108. TX 107 typically transmits RF signals at a power level according to commands received by radio 104 from a cellular basestation (not shown). As the distance between mobile device 101 and the basestation increases, the basestation typically commands the mobile device 101 to increase the transmit power level from TX 107. As the transmit power level increases, the power consumption of TX 107, and thus radio 104, increases dramatically.

Meanwhile, MTPC 106 controls the maximum transmit power level of TX 107, and thus can be used to limit the maximum rise in power consumption by radio 104. Since microprocessor 102 controls the operating modes of mobile device 101 and thus maintains an accurate estimate of the overall power consumption of the mobile device 101, microprocessor 102 can also determine a reasonable remainder of power to be allocated to the radio 104. Thus, microprocessor 102 communicates with MTPC 106 to indicate to MTPC the amount of power available to radio 104, and MTPC 106 thus can determine the maximum allowed power consumption of radio 104. MTPC 106 may utilize a look-up table to calculate the maximum transmit power level to be allowed on radio 104 based on the known power consumption of TX 107 operating at various maximum transmit power levels, in order to conform to this maximum allowed power consumption of the radio 104 as communicated to MTPC 106 by microprocessor 102. MTPC 106 provides the maximum transmit power level information to the baseband section 105, which in turn uses this maximum power limit when controlling the output transmit power level of TX 107. Thus, MTPC 106 functions as a maximum transmit power controller that determines the amount of power available from the host device (which in this cases is the mobile device 101) and sets the maximum transmit power level in the radio transmitter 107 so as not to exceed such determined amount of available power.

Often, the degree to which the maximum transmit power level of TX 107 in radio 104 may be reduced is limited by regulatory requirements. For example, the maximum transmit power of radio 104 (as measured at the antenna connector) must fall in the range of +21 dBm to +25 dBm, according to certain 3 Gpp cellular specifications (25.101). Thus, in radios conforming to these specifications, MTPC 106 may not reduce the transmit power level from TX 107 below the level of +21 dBm.

In certain circumstances, according to the same cellular specifications, the transmit power level may be reduced further, depending on characteristics of amplitude modulation in the transmitted RF signal, as determined by the transmitted signal's cubic metric. Cubic Metric is a measure related to the peak-to-average amplitude levels of the modulation of the transmit signal; a higher cubic metric allows for a lower maximum transmit power level in the cellular specifications. Thus, MTPC 106 may take into account the cubic metric of the transmitted RF signal when determining the maximum transmit power level of TX 107. In addition to the power available from the mobile device 101, other regulatory constraints, as well as signaling types (e.g. duty cycle) and environmental constraints (e.g. temperature) may further influence how the maximum transmit power level of TX 107 is set by MTPC 106.

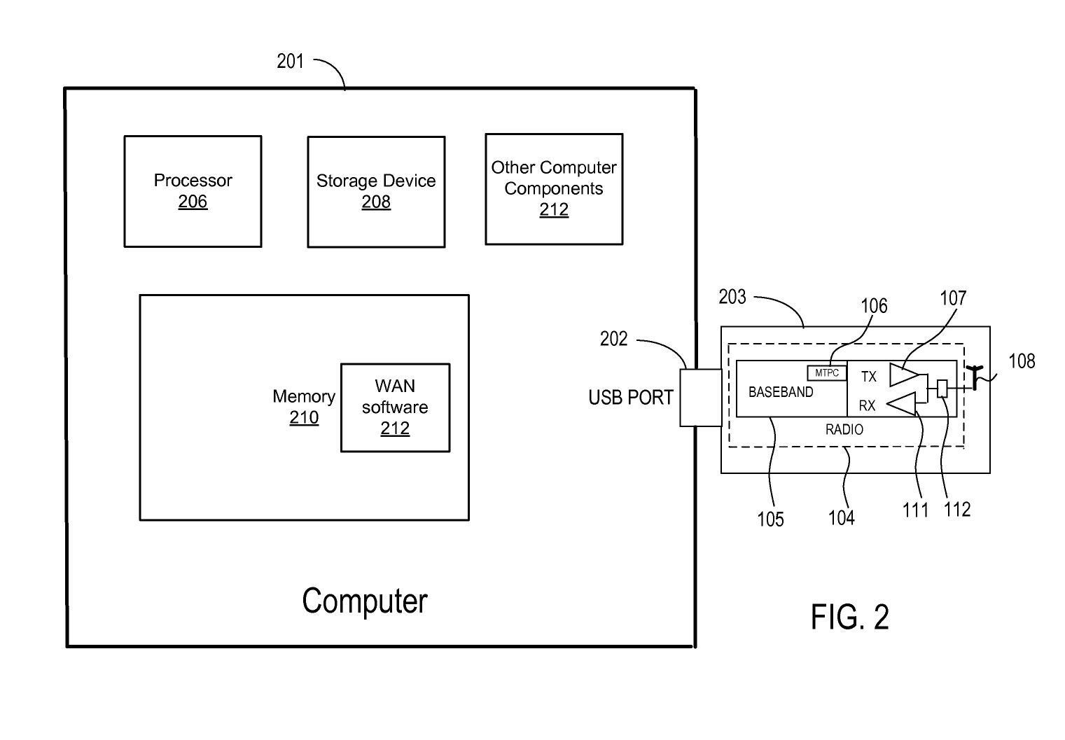

FIG. 2 illustrates a maximum transmit power controller according to another embodiment. FIG. 2 shows a computer 201, which may be a notebook PC or any other type of mobile computing device, which features at least one peripheral interface such as a USB (Universal Serial Bus) port 202 for attachment of peripheral devices. Computer 202 also includes conventional computer components such as a processor 206, a storage device 208, a memory 210, and other conventional components 212 (details not provided herein). A wireless WAN modem, USB WAN modem 203, is plugged into USB port 202. Modem 203 may provide wireless data connectivity for the computer 201 with a cellular network; thus the computer 201 may be connected to the internet through the cellular network. Modem 203 communicates data and other control signals with computer 201 via USB port 202 for transmission or receipt of such data or control signals through the cellular network. Modem 203 is also powered by the USB port 202 of host computer 201. Although the embodiment in FIG. 2 illustrates the example in which the modem 203 is powered by a USB interface 203, other types of computer peripheral interfaces capable of providing power to the attached peripheral devices may also be used with the embodiment of FIG. 2. As in the embodiment of FIG. 1, radio 104 includes an RF transmitter 107 which transmits an RF signal through antenna 108, an RF receiver 111 which receives RF signals through antenna 108, a duplexer 112, and a baseband section 105. The baseband section 105 may be a processor which includes software for processing radio signals, and includes Maximum Transmit Power Controller (MTPC) block 106. MTPC block 106 may include a lookup table which provides information of the power consumption of radio 104 versus transmitting power level of TX 107.

As explained above, USB interface 202 provides power to the peripheral device attached to it, which is modem 203 in the embodiment of FIG. 2. USB ports conforming to USB 2.0 specifications provide up to 500 mA (5V), after the peripheral device is configured to operate with this port, while those ports conforming to USB 3.0 specifications may provide up to 900 mA. Further power may be available from a special receptacle, raising the power limit to over 1000 mA. Thus, USB WAN modem 203 must operate with a variety of operating power limits, depending on whether USB port 202 conforms to USB 2.0 or USB 3.0 specifications. There may be further power constraints as well, depending on conditions such as the current drawn by other peripherals attached to other USB ports on computer 201.

WAN software 204 may be an executable program stored in memory 210 and running on the processor 206 of computer 201 which monitors these power constraints of the USB interface 202. For example, WAN software 204 may query the computer's registry (not shown) to determine which specifications the USB ports 202 conform to. WAN software 204 may also query the computer's power management system (not shown) to calculate the power available for WAN modem 203 through USB port 202. WAN software 204 then reports these constraints to USB WAN modem 203 by communicating across USB port 202, ultimately reporting this information to MTPC 106.

As in the embodiment of FIG. 1, MTPC 106 in the embodiment of FIG. 2 may also utilize a look-up table to calculate the maximum transmit power level allowed based on the known power consumption of TX 107 operating at various maximum transmit power levels, in order to conform to this maximum allowed power consumption of the radio 104 as communicated from WAN software 204 to MTPC 106. MTPC 106 provides the maximum transmit power level information to the baseband section 105, which in turn uses this maximum transmit power limit when controlling the output transmit power level of TX 107 so as not to exceed such maximum transmit power level. Thus, again, MTPC 106 functions as a maximum transmit power controller that determines the amount of power available from the host device (which in this cases is the computer 201) and sets the maximum transmit power level in the radio transmitter 107 so as not to exceed such determined amount of available power.

While the specific example of a USB (Universal Serial Bus) peripheral interface is described, it should be recognized that the invention described could include other peripheral interfaces. For example, PCI and PCI Express interfaces are commonly used in conjunction with peripheral devices such as WAN modems. In some cases, the WAN modem, while considered a peripheral device, may be physically installed inside the computer in a bus card slot, for example.

Upon reading this disclosure, those of skill in the art will appreciate still additional alternative designs for a maximum transmit power controller. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of controlling a transmit power level of a radio of a mobile communication device powered by a host device, the method comprising:
determining an amount of power available from the host device; and
setting a maximum transmit power level of the radio so as not to exceed the determined amount of power available from the host device.

2. The method of claim 1, wherein a microprocessor of the host device determines the amount of power available from the host device.

3. The method of claim 1, further comprising calculating the maximum transmit power level of the radio using a look-up table that stores power consumption of the radio at a plurality of transmit power levels.

4. The method of claim 1, wherein the maximum transmit power level of the radio is reduced to a minimum allowed by regulatory requirements.

5. The method of claim 1, wherein the maximum transmit power level of the radio is set according to a modulation type of the transmit signal of the radio.

6. The method of claim 1, wherein the maximum transmit power level of the radio is set according to a peak-to-average amplitude level of modulation of the transmit signal of the radio.

7. The method of claim 1, wherein the maximum transmit power level of the radio is set according to temperature.

8. The method of claim 1, wherein the host device is a smartphone and the radio is included in the smartphone.

9. The method of claim 1, wherein the host device is a computer and the mobile communication device is powered by the computer via a peripheral interface of the computer.

10. The method of claim 9, further comprising transmitting information on the amount of power available from the host device to the mobile communication device via the peripheral interface.

11. The method of claim 9, wherein the peripheral interface is a USB (Universal Serial Bus) interface.

12. The method of claim 11, further comprising adjusting the amount of power available from the host device based on whether at least another device in addition to the mobile communication device is connected to the USB interface.

13. The method of claim 11, further comprising adjusting the amount of power available from the host device based on a type of the USB interface.
